(19) United States
(12) Patent Application Publication
(10) Pub. No.: US 2015/0041412 A1
(43) Pub. Date: Feb. 12, 2015

(54) Polyionic Molecular Diffuser and Filter Method

(71) Applicants: Gustavo Solis Cortes, San Diego, CA (US); Luis Pablo Díaz-Rivera González, San Diego, CA (US)

(72) Inventors: Gustavo Solis Cortes, San Diego, CA (US); Luis Pablo Díaz-Rivera González, San Diego, CA (US)

(21) Appl. No.: 14/072,216

(22) Filed: Nov. 5, 2013

Related U.S. Application Data
(60) Provisional application No. 61/828,539, filed on May 29, 2013.

(51) Int. Cl. B01F 3/04; C02F 1/72

(52) U.S. Cl. CPC B01F 3/04262; C02F 1/72; B01F 2003/04319; B01F 2003/04361
USPC 210/758; 55/502; 261/122.1

(57) ABSTRACT

A Polyionic Molecular Diffuser and Filter Method. The device and method provides superlative filtration in macro, micro and nano ranges for a variety of fluids. The device utilizes filtration elements that are relatively low cost, yet provide the significant advantage of being able to be back-flushed periodically to remove captured solids. The device employs an arrangement of filter elements wherein the filtration axis of the filters is perpendicular to the flow axis of the collecting housing. The device and method further provides a way for adjusting filter to capture different sizes of solids, depending upon the particular user adjustment. This same filter is adaptable to operate as a gas diffuser that will diffuse gas into a liquid in a very controllable manner, while also purifying the diffused air.

This application is filed within one year of, and claims priority to Provisional Application Ser. No. 61/828,539, filed May 29, 2013.

### BACKGROUND OF THE INVENTION

1. Field of the Invention

This invention relates generally aerators for liquids and, more specifically, to a Polyionic Molecular Diffuser and Filter Method

2. Description of Related Art

Filters of many designs and configurations have been used in many fields, and for filtering many fluids, including air, oil, water and many others. Whatever the type of conventional filter, it is normal that they be configured in different filtration sizes in order to obtain different results (and to be used with different fluid viscosities), ranging from nano- and micro- to macro-filtration. As filters begin to trap more and more material, they begin to clog and create a pressure drop as well as to block fluid flow. At some point, just about every type of filter element must be replaced due to this fouling.

There is thus a widely held need to avoid this fouling problem because of the efficiency reductions of the system, as well as to avoid unnecessary replacement costs for new filters.

A side benefit of these types of filter media is that it can be used very effectively as a gas-into-liquid diffuser. The parallel plates serve well to convert incoming gas (e.g. air) into bubbles of controllable size, for the purpose of aerating the liquid. The device would be suitable to filter dirty air, as the gas will leave the liquid absent of any suspended material or fumes (such as from cigarettes). The system could be used to aerate liquid in fish tanks, water treatment plants, lakes.

Furthermore, as a filter, the device out-performs a conventional centrifugal fuel filter (e.g. diesel fuel) because, unlike centrifugal filters, the design of the present invention does not separate any components from the fuel (i.e. the heavier lubricating components). Also, it is believed that the fueal molecules are “smoothed” as they pass through the parallel plates, thereby improving their combustion within an engine.

### SUMMARY OF THE INVENTION

In light of the aforementioned problems associated with the prior devices and methods, it is an object of the present invention to provide a Polyionic Molecular Diffuser and Filter Method. The device and method should provide superlative filtration in macro, micro and nano ranges for a variety of fluids. The device should use filtration elements that are relatively low cost, yet provide the significant advantage of being able to be back-flushed periodically to remove captured solids. The device should employ an arrangement of filter elements wherein the filtration axis of the filters is perpendicular to the flow axis of the collecting housing. The device and method should further provide a way for adjusting filter to capture different sizes of solids, depending upon the particular user adjustment. This same filter should be adaptable to operate as a gas diffuser that will diffuse gas into a liquid in a very controllable manner.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a cutaway side view of one embodiment of the diffuser assembly of present invention;

FIG. 2 is a cutaway side view of a preferred embodiment of the bubbler of the present invention, utilizing the assembly of FIG. 1;

FIGS. 3A and 3B are partially exploded views of the diffuser assembly of FIG. 1;

FIG. 4 is a top view of an intermediate diffuser plate of the assembly of FIGS. 1 and 3;

FIG. 5 is a front perspective view of a stack of diffuser plates of the present invention;

FIG. 6 depicts the operation of the bubbler of FIG. 2 in terms of bubble size as a function of diffuser stack compressive force; and

FIG. 7 is a partially exploded view of a modified version of the assembly of FIGS. 1, 3 and 4.

### DETAILED DESCRIPTION OF THE PREFERRED EMBODIMENTS

The following description is provided to enable any person skilled in the art to make and use the invention and sets forth the best modes contemplated by the inventors of carrying out their invention. Various modifications, however, will remain readily apparent to those skilled in the art, since the generic principles of the present invention have been defined herein specifically to provide a Polyionic Molecular Diffuser and Filter Method.

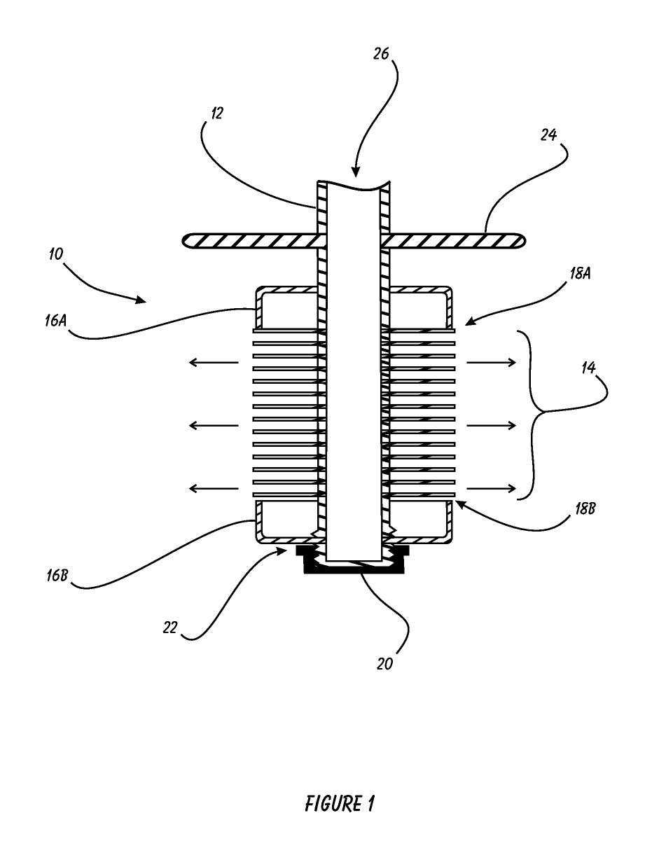

The present invention can best be understood by initial consideration of FIG. 1.¹ FIG. 1 is a cutaway side view of one embodiment of the diffuser assembly 10 of present invention. The assembly 10 is preferably defined by a central diffuser pipe 12 running down its length. A series of flat diffuser plates (generically 14) are captured between a pair of compression caps 16A, 16B. ¹ As used throughout this disclosure, element numbers enclosed in square brackets [ ] indicates that the referenced element is not shown in the instant drawing figure, but rather is displayed elsewhere in another drawing figure.

As will be depicted below, the diffuser pipe 12 has a plurality of perforations, such as slots, formed along its length. Gas entering the diffuser pipe 12 from a gas supply 26 will exit through the perforations formed in the pipe 12, and eventually out through the slight gaps between the diffuser plates 14.

A variety of materials may be employed for the layers 14, but it has been demonstrated that “optical” precision filter elements (i.e. very high precision) demonstrate extremely suitable results. The diffuser layers 14 are held together by compression caps 16A, 16B.

The compression caps or bells 16A, 16B may be of a similar planar configuration to the diffuser plates 14, although it may be slightly larger or smaller in diameter in order to avoid any centering issues. In the depicted version, however, the caps 16A, 16B actually have a concave bell shape that causes the upper rim of the caps 16A, 16B to be the point of contact between the plate 16A, 16B and the diffuser layers 14—this design has been demonstrated as particularly successful because it creates an outer boundary diffusion layer, with an inner core the causes less of a flow restriction.

The compression caps 16A, 16B are pressed against the stack of diffuser layers 14 by an end cap 20, which threadedly engages the distal end of the diffuser pipe 12. It should be apparent from the arrangement of the elements in the assembly 10 that if the end cap 20 is tightened or loosened, it will squeeze or release squeezing force against the stack of diffuser layers 14. By adding compression to the stack of layers 14 (by tightening the end cap 20), the diffuser stack height will be reduced and the gap between each layer 14 will be reduced. Conversely, if compression is reduced by loosening the end cap 20, the diffuser stack height will increase due to the gap between each layer 14 increasing.

In order to direct as much of the gas as possible to flow out through the diffuser layers 14, there could be sealing rings 18A, 18B at each compression cap 16A, 16B. There may also be a sealing ring 22 on the inner face of the end cap 20.

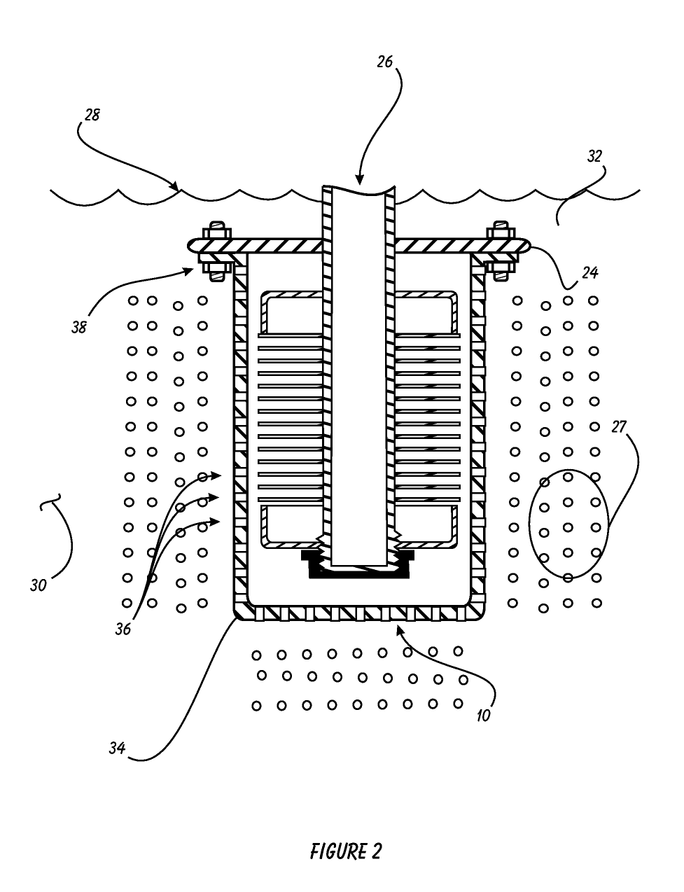

A further feature is that there is preferably a housing base plate 24 attached (e.g. welded) to the diffuser pipe 12. This provides a secure and stable mounting point for the other elements of the housing, as shown in FIG. 2.

FIG. 2 is a cutaway side view of a preferred embodiment of the bubbler 28 of the present invention, utilizing the assembly 10 of FIG. 1. Here, the bubbler 28 is depicted while in operation, so that the gas supply 26 is being diffused into the liquid 30 in the form of small bubbles 27. The bubbler 28 will typically be anchored well below the surface 32 of the liquid reservoir 30, but this orientation certainly depends upon the operational circumstances.

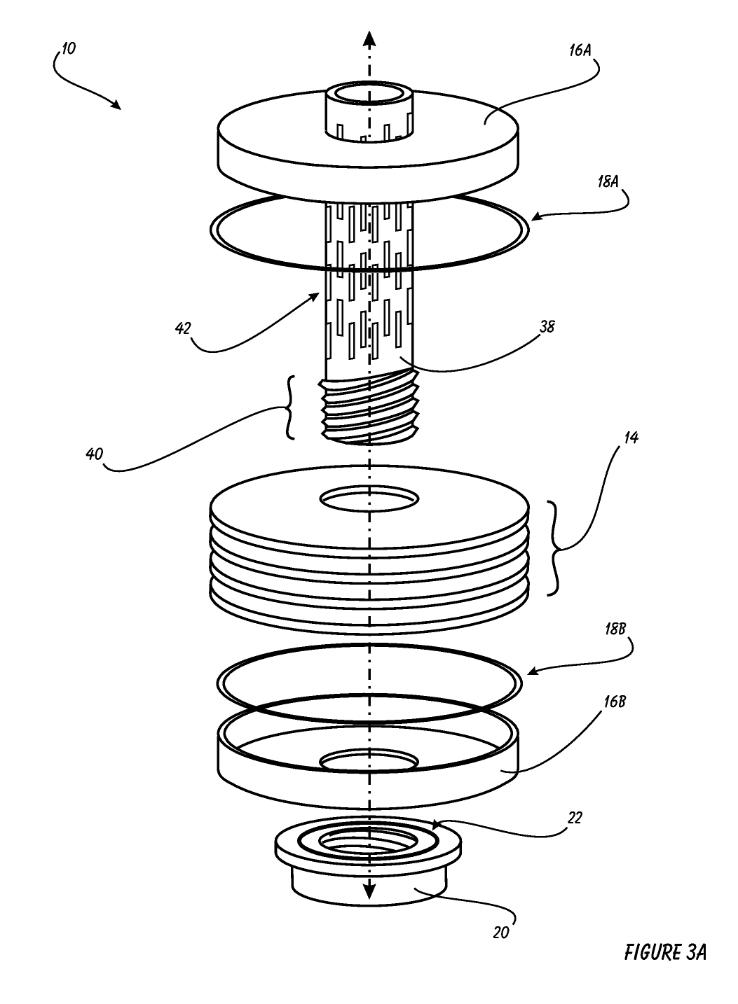

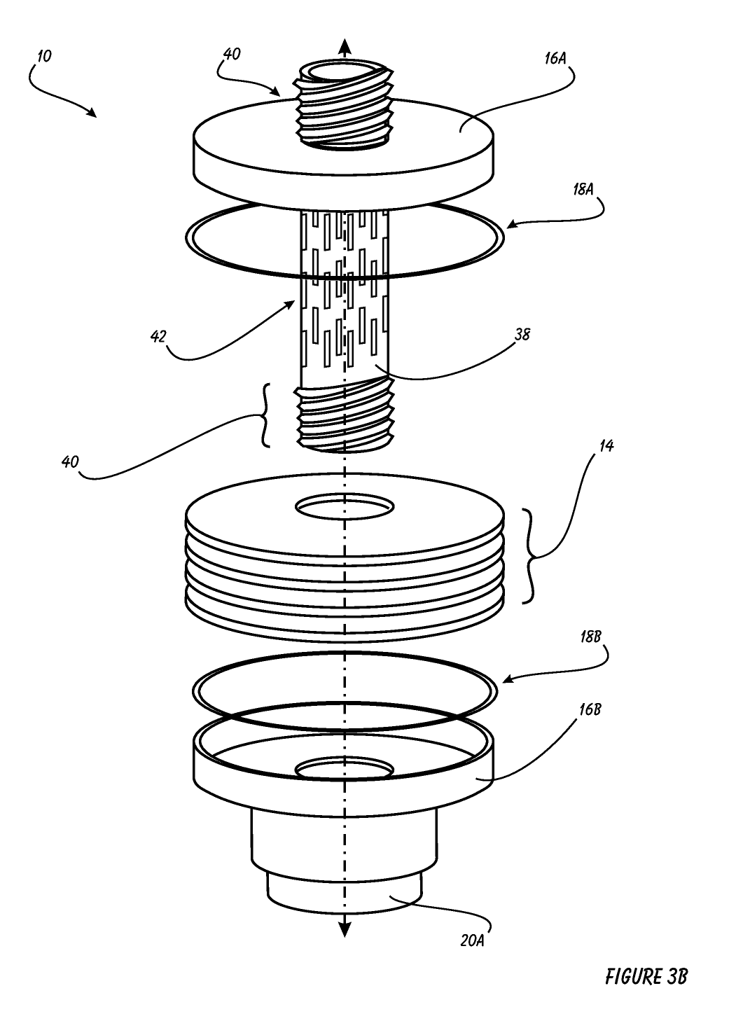

The diffuser assembly 10 is ideally housed within a housing—the housing is comprised of a housing cannister 34 attached to the housing base plate 24 by a plurality of fasteners 38 (such as bolts and nuts). The housing cannister 34 has a plurality of apertures 36 formed through it that allows the gas bubbles 27 to exit, while still protecting the diffuser assembly 10 from damage or fouling. The diffuser assembly 10 is depicted in yet another way in FIG. 3.

FIG. 3A is a partially exploded view of the diffuser assembly 10 of FIG. 1. Specifically detailed here are the slots 42 formed along the length of the diffuser pipe 38—these slots 42 serve to allow the gas to be pushed through the diffuser plates 14 evenly. The diffuser pipe 38 terminates in a threaded portion 40, which is where the end cap 20 threadedly attaches.

The end cap 20 ideally has a sealing ring 22 on its face that will create a solid seal against the compression cap 16B when the end cap 20 is tightened until it compresses against the compression cap 16B. The sealing ring 22 could be an individual element as shown, or it could be incorporated into the end cap 20 (in other versions).

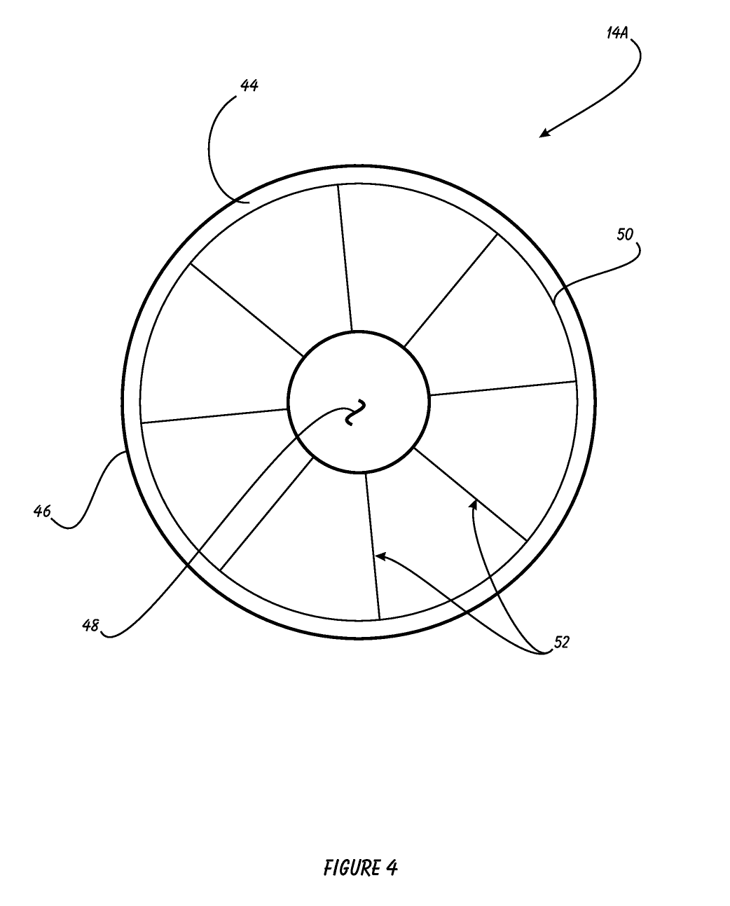

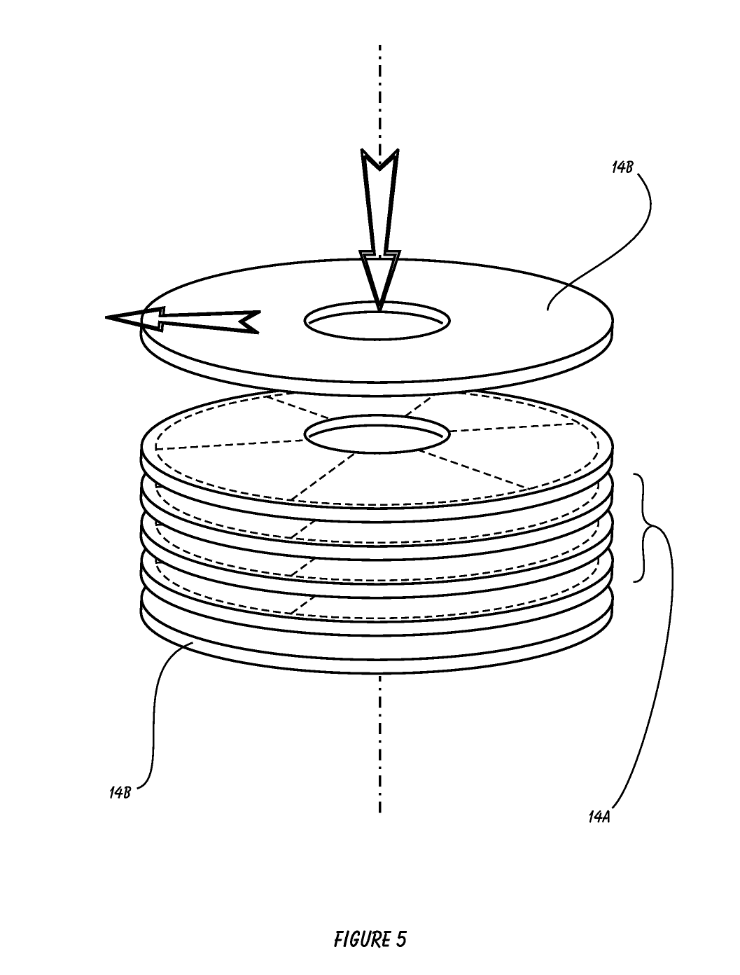

Similarly, sealing rings 18A and 18B are disposed between the compression caps 16A, 16B and the adjacent diffuser plate 14. The diffuser plates 14 are not necessarily all identical, as discussed in connection with FIGS. 4 and 5.

FIG. 3B depicts an alternate design. In this version, the end cap 20A and compression cap 16B are integrated into a single component. Also, the top end of the diffuser pipe 38 has a threaded portion 40 at its end for attachment to gas supply piping.

FIG. 4 is a top view of an intermediate diffuser plate 14A of the assembly of FIGS. 1 and 3. In order to improve the radial distribution of the out-flowing gas through the plates 14A, a series of cuts or grooves are formed in one or both faces of the substrate 44 comprising the intermediate diffuser plates 14A. There are a plurality of radial grooves 52 interconnecting the center aperture 48 formed in the substrate 44 with an outer peripheral groove 50. The peripheral groove 50 is adjacent to, and inboard of the outer edge 46 of the substrate. Testing has revealed that it is optimum that the groove 50 is very close to the outer edge of the substrate 44.

The grooves 50, 52 may be cut into a wide variety of profiles and/or shapes, depending upon the gas being diffused and the environment for the application. As shown in FIG. 5, the top-most end diffuser plates 14B will most likely not have the grooves 50, 52 cut into them (at least not on the sides that face outwardly from the center of the stack). This is so that a strong gas-tight seal can be formed between the end diffuser plates 14B and the sealing rings [18A, 18B].

Additional testing has revealed that widening the grooves 50, 52 (without making them deeper) results in increased flow of air or fluid (depending upon the application for the assembly 10. A lower restriction on flow results ni greater throughput for the filter/bubbler.

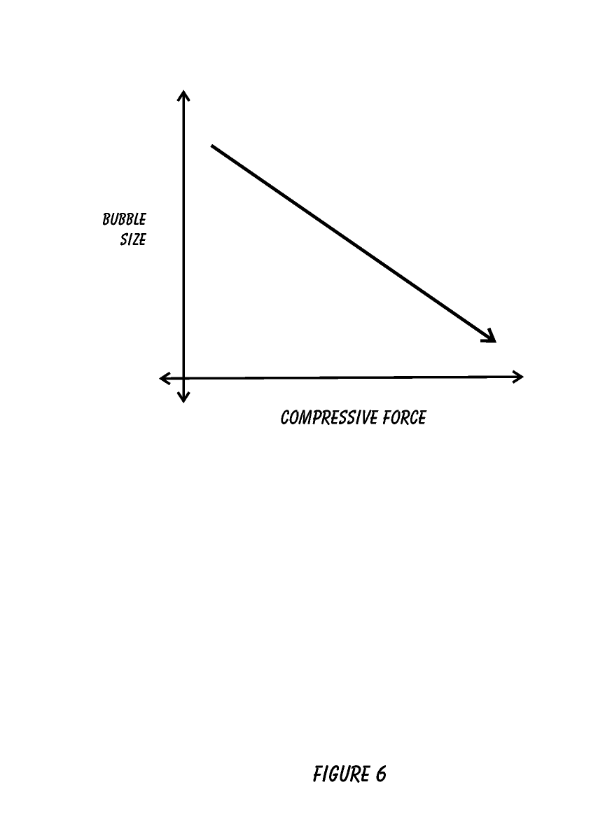

As discussed previously, the compressive force imposed on the stack of diffuser plates is controllable in order to control the size of the bubbles that are being emitted by the bubbler [28]. FIG. 6 depicts this trend.

Yet another benefit provided by the instant design is a prolonged lifespan. The plates [collectively 14] do not need to be periodically replaced, since the assembly [10] can be back-flushed with liquid to clean out any captured particulates or other contaminants.

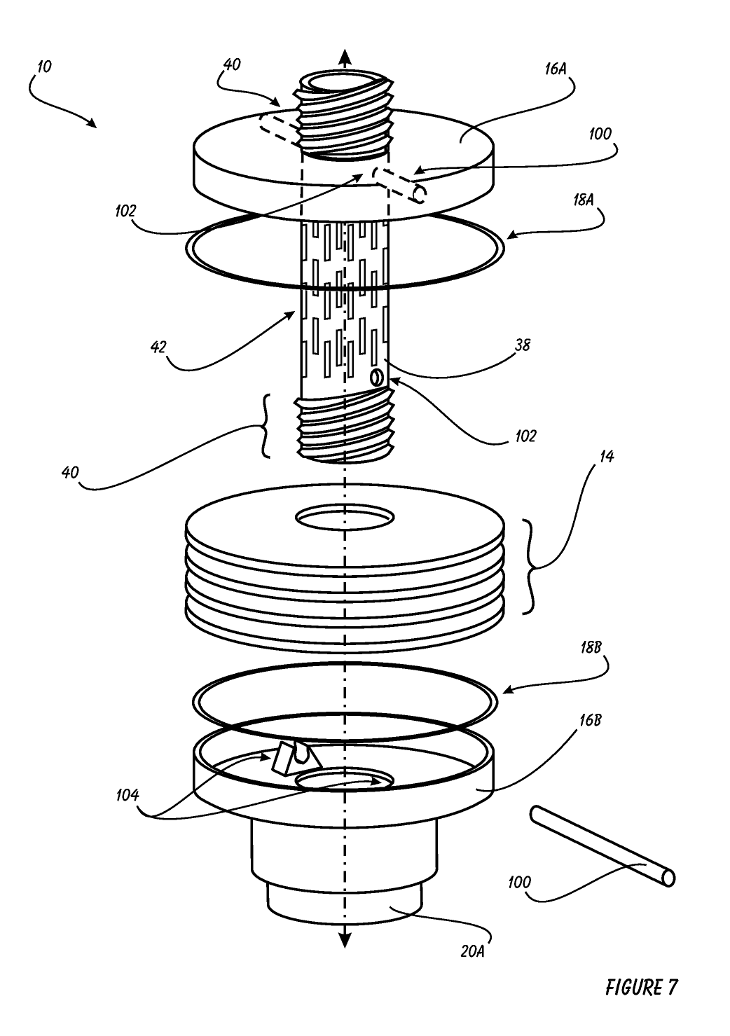

Another improvement to the instant device is depicted in FIG. 7. FIG. 7 is a partially exploded view of a modified version of the assembly of FIGS. 1, 3 and 4. Of particular interest in this view is the addition of the keeper pegs 100 that engage apertures 102 formed in the diffuser pipe 38. As the device 10 is assembled, the pegs 100 are inserted through the apertures 102 at each end of the diffuser pipe 38. The compression caps 16A, 16B are equipped with cradle brackets 104 on either side of the central hole formed in the caps 16A, 16B. The pegs 100 fit into the brackets 104 when the caps 16A, 16B are fitted over the diffuser pipe 38. These pegs 100 will prevent the compression caps 16A, 16B from turning after the assembly 10 is fully assembled. There is enough room in the brackets 104 to allow the compression caps 16A, 16B to travel slightly along the diffuser pipe 38, as necessary, if the end caps 20 are tightened.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A filter, comprising:
a housing defined by:
a base plate having an inlet aperture formed therethrough;
a cannister attached to said base plate to form an internal chamber, said cannister walls defined by a plurality of small apertures formed therethrough;
a diffuser pipe passing through said inlet aperture and into said internal chamber, said diffuser pipe formed with a plurality of elongate slots penetrating the wall of said diffuser pipe between the inside of said diffuser pipe and the outside of said diffuser pipe, said diffuser pipe defining a longitudinal axis and terminating in a distal end inside of said internal chamber;
three or more thin plates forming a stack defining a planar axis perpendicular to said longitudinal axis, said diffuser pipe passing through central apertures in said thin plates of said stack, such that said elongate slots are covered by said stack;
upper and lower sealing rings atop and below said stack of plates;
upper and lower compression plates atop and below said respective sealing rings; and
an end cap engaging said distal end to compress said stack of thin plates between said compression plates.

2. The filter of claim 1, wherein said distal end of said diffuser pipe is defined by external threads therearound, and said end cap threadedly engages said external threads.

3. The filter of claim 2, wherein said end cap further has an end cap sealing ring compressed between said end cap and said lower compression plate.

4. The filter of claim 3, wherein said upper sealing ring is compressed between said upper compression plate and a top said thin plate.

5. The filter of claim 4, wherein said lower sealing ring is compressed between said lower compression plate and a lower said thin plate.

6. The filter of claim 5, further comprising a plurality of bolts and nuts attaching said cannister to said base plate.

7. The filter of claim 6, wherein one or more of said plates in said stack are further defined by a plurality of radial grooves in relative spaced relation and a peripheral groove cut in a face thereof.

8. A method for introducing gas into a fluid, comprising the steps of:
introducing said gas into a elongate diffuser pipe defined by elongate slots formed longitudinally along a portion of its length, said diffuser pipe located within an outer submersible housing;
first passing said gas through said elongate slots and into radial gaps formed between a stack of ring-shaped plates surrounding said elongate slots;
second passing said gas through said radial gaps an into the interior of said submersible housing; and
finally passing said gas through perforations formed in said submersible housing.

9. The method of claim 8, wherein said first passing step comprises passing said gas through radial grooves formed in said ring-shaped plates.

10. A liquid-submersible gas filter, comprising:
a submersible housing defined by:
a base plate having an inlet aperture formed therethrough;
a cannister attached to said base plate to form an internal chamber, said cannister walls defined by a plurality of small apertures formed therethrough;
a gas diffuser pipe passing through said inlet aperture and into said internal chamber, said gas diffuser pipe formed with a plurality of elongate slots penetrating the wall of said diffuser pipe between the interior of said gas diffuser pipe and the exterior of said gas diffuser pipe, said gas diffuser pipe defining a longitudinal axis and terminating in a threaded distal end inside of said internal chamber;
three or more thin plates forming a stack defining a planar axis perpendicular to said longitudinal axis, said gas diffuser pipe passing through central apertures in said thin plates of said stack, such that said gas diffuser pipe elongate slots are covered by said stack;
upper and lower sealing rings atop and below said stack of plates, respectively;
upper and lower compression plates atop and below said respective sealing rings; and
an end cap engaging said threads at said distal end to compress said stack of thin plates between said compression plates.

11. The liquid-submersible filter of claim 10, wherein said end cap further has an end cap sealing ring compressed between said end cap and said lower compression plate.

12. The liquid-submersible filter of claim 11, wherein said upper sealing ring is compressed between said upper compression plate and a top said thin plate.

13. The liquid-submersible filter of claim 12, wherein said lower sealing ring is compressed between said lower compression plate and a lower said thin plate.

14. The liquid-submersible filter of claim 13, wherein said distal end of said diffuser pipe is defined by external threads therearound, and said end cap threadedly engages said external threads.

15. The liquid-submersible filter of claim 14, wherein rotating said end cap alternately increases or decreases compressive forces between said upper and lower compression plates and said stack of thin plates.

16. The liquid-submersible filter of claim 10, further comprising a plurality of bolts and nuts attaching said cannister to said base plate.

17. The liquid-submersible filter of claim 10, wherein one or more of said plates in said stack are further defined by a plurality of radial grooves in relative spaced relation and a peripheral groove cut in a face thereof.
